(19) United States
(12) Patent Application Publication
(10) Pub. No.: US 2013/0173517 A1
(43) Pub. Date: Jul. 4, 2013

(54) METHOD AND APPARATUS FOR COORDINATING CONTENT ACROSS DEVICES BASED ON STIMULI

(71) Applicant: Bernard Berus, Berlin (DE)

(72) Inventor: Bernard Berus, Berlin (DE)

(73) Assignee: Nokia Corporation, Espoo (FI)

(21) Appl. No.: 13/341,234

(22) Filed: Dec. 30, 2011

(51) Int. Cl. G06N 5/00

(52) U.S. Cl. 706/45

(57) ABSTRACT

An approach for coordinating the rendering of related content across devices of a user based on determined environmental stimuli is described. A content provisioning platform determines one or more samples of one or more environmental signals. The content provisioning platform also processes the one or more samples to cause identification of content presented in the one or more environmental signals. Transmission of the other content to the at least one device, one or more other associated devices is then caused.

### BACKGROUND

Content providers typically convey targeted advertisements, messages, applications and other content to users by way of television programming, email, multimedia presentations, radio broadcasts and the like. Consequently, users are able to interact with the content, view it or listen to it via a television, a radio, a desktop computer or a mobile device such as a Smartphone or tablet device. In some instances, users may even have access to multiple devices at a time. For example, a user may be watching a television program at home while surfing the internet with their laptop computer and/or engaging a friend via their Smartphone. While all of these devices are capable of rendering content, they operate disparately. Unfortunately, there is currently no convenient means of coordinating the rendering of related content across disparate devices.

### SOME EXAMPLE EMBODIMENTS

Therefore, there is a need for an approach for coordinating the rendering of related content across devices of a user based on determined environmental stimuli.

According to one embodiment, a method comprises determining one or more samples of one or more environmental signals, wherein the one or more samples are captured by at least one device. The method also comprises processing and/or facilitating a processing of the one or more samples to cause, at least in part, an identification of content presented in the one or more environmental signals. The method further comprises causing, at least in part, a transmission of other content to the at least one device, one or more other associated devices, or a combination thereof, wherein the other content is related to the identified content.

According to another embodiment, an apparatus comprises at least one processor, and at least one memory including computer program code for one or more computer programs, the at least one memory and the computer program code configured to, with the at least one processor, cause, at least in part, the apparatus to determine one or more samples of one or more environmental signals, wherein the one or more samples are captured by at least one device. The apparatus is also caused to process and/or facilitate a processing of the one or more samples to cause, at least in part, an identification of content presented in the one or more environmental signals. The apparatus further causes, at least in part, a transmission of other content to the at least one device, one or more other associated devices, or a combination thereof, wherein the other content is related to the identified content.

According to another embodiment, a computer-readable storage medium carries one or more sequences of one or more instructions which, when executed by one or more processors, cause, at least in part, an apparatus to determine one or more samples of one or more environmental signals, wherein the one or more samples are captured by at least one device. The apparatus is also caused to process and/or facilitate a processing of the one or more samples to cause, at least in part, an identification of content presented in the one or more environmental signals. The apparatus is further caused to, at least in part, transmit other content to the at least one device, one or more other associated devices, or a combination thereof, wherein the other content is related to the identified content.

According to another embodiment, an apparatus comprises means for determining one or more samples of one or more environmental signals, wherein the one or more samples are captured by at least one device. The apparatus also comprises means for processing and/or facilitating a processing of the one or more samples to cause, at least in part, an identification of content presented in the one or more environmental signals. The apparatus further comprises means for causing, at least in part, a transmission of other content to the at least one device, one or more other associated devices, or a combination thereof, wherein the other content is related to the identified content.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of coordinating the rendering of related content across devices of a user based on determined environmental stimuli, according to one embodiment;

FIG. 2 is a diagram of the components of a content provisioning platform, according to one embodiment;

FIGS. 3A-3C are flowcharts of processes for coordinating the rendering of related content across devices of a user based on determined environmental stimuli, according to various embodiments;

FIGS. 4A and 4B are diagrams of user interfaces utilized in the processes of FIGS. 3A-3C, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for coordinating the rendering of related content across devices of a user based on determined environmental stimuli are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to video, audio and multimedia content, it is contemplated that the approach described herein may be used with other forms of content capable of being executed by a device. The exemplary embodiments may be utilized for the processing of any content capable of being rendered to and/or shared with a user interface, device component interface (e.g., speaker system), or the like for visual and/or auditory execution.

Also, while various embodiments are described with respect to environmental signals (or stimuli) provided by a television or radio, it is contemplated the approach described herein may apply to any device or source capable of transmitting or generating signals. This may include, for example devices such as mobile devices, computing devices and audio transmitters or people, animals, machines, natural occurrences or any other phenomena or objects detectable by a data capturing device.

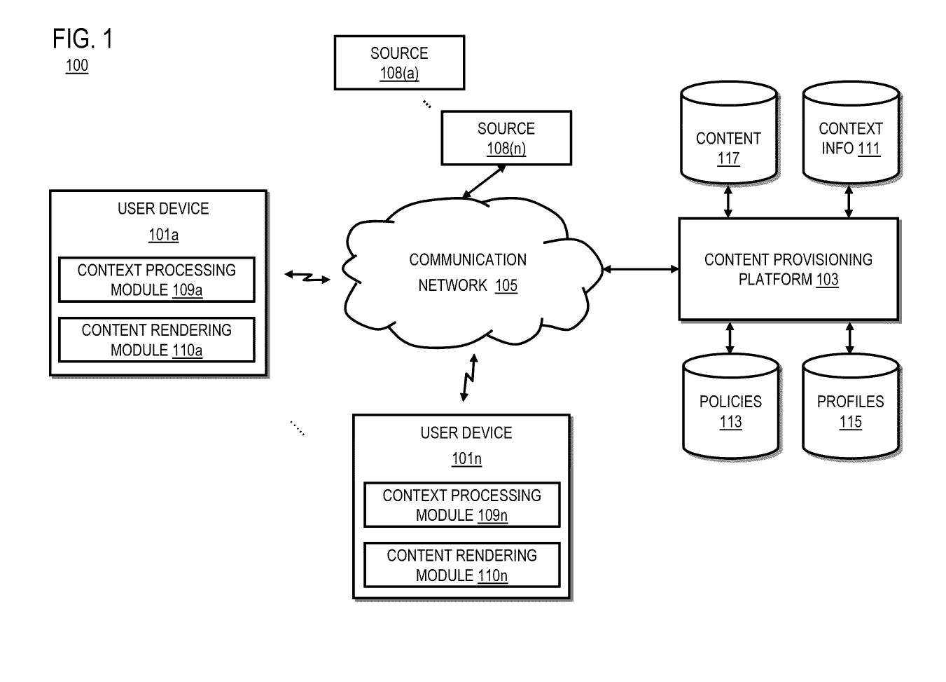

FIG. 1 is a diagram of a system capable of coordinating the rendering of related content across devices of a user based on determined environmental stimuli, according to one embodiment. The system 100 includes a content provisioning platform 103 that is configured to enable content, as provided by a common content provider, to be rendered across multiple different user devices in a synchronized, coordinated manner. In addition, the content provisioning platform 103 enables a user device to detect and process one or more samples of environmental signals—i.e., audio signals—provided by a source 108a-108n. Subsequent processing of the sample is then performed to trigger the retrieval and subsequent transmission of content related to the sample for rendering at one or more devices of a user. It is noted, therefore, that the content provisioning platform 103 operates in conjunction with various devices of a user to make them sensitive to environmental stimuli for ensuring coordinated content presentment and/or execution based on said stimuli.

Many of today's user devices and consumer electronics, such as televisions, computers and mobile phones, feature rich displays and audio systems (e.g., speakers) for rendering content. For example, a service provider or product manufacturer may present a television commercial for broadcast over one or more channels. In addition, a web based advertisement can be deployed by the service provider for to be viewed by a plurality of users via their Smartphone, desktop computer, or other computing device. In this example, even though the content is related to the same product or service provider, the format in which they are presented is different. Furthermore, given the different mediums over which the content is rendered—i.e., formatted for television versus formatted for a mobile device—the content is often viewed or listened to by the user at different times despite the availability of multiple user devices at a time. Unfortunately, there is currently no convenient means of coordinating the rendering of related content across disparate devices available to a user.

To address this problem, a system 100 of FIG. 1 introduces the capability to determine one or more samples of environmental signals as captured by a device. The environmental signals may include, for example, audio and video signals as generated by a radio, television, person, group or other source 108a-108n (e.g., a kinetic source or auditory source). For the purpose of illustration, the environmental signals may pertain to programmed content as conveyed by a source or incidental content as conveyed by a source. Programmed content may include, for example, television broadcasts, radio broadcasts, podcasts, multimedia and/or streaming content sessions and the like that are executed by the source in accordance with a schedule. In the case of television or radio broadcasts, the programmed content includes talk shows, music sessions, etc., for play at designated stations and/or channels. Incidental content may include, for example, signals produced by various objects, people, machinery, or other naturally occurring phenomenon, often randomly. Under this scenario, the incidental content includes talking, alerts, events, etc. It is noted that the content provisioning platform 103 is configured to associate any type of environmental signal with a corresponding set of target content 117 based on analysis of a sample of said environmental signal.

In certain embodiments, the samples as captured by a device may also pertain to light signals and network signals samples (i.e., a collection of datagrams for conveying a network, session or communication condition). A user device 101a-101n may be equipped with various sensing devices, including sound recorders, video recorders, image capturing sensors and the like for supporting capture and sampling of the environmental signals. Hence, the samples may represent a segment or portion of an overall signal, that segment comprising one or more audible sounds, keywords, images, data types or the like for being processed by a content provisioning platform 103.

As noted, a content provisioning platform 103 is configured to operate in connection with the user devices 101a-101n for processing the samples as captured. This processing includes, for example, analyzing the samples using one or more content and data recognition techniques for determining a correlation between at least one sample and target content 117 to be rendered to a user device 101a-101n. By way of example, the platform 103 can process an audio signal sampled by a device and determine the sample includes the terms “Super Product X.” Based on this sample, as well as context information associated with the device that provided the sample, the platform 103 then performs a correlation process. The correlation procedure is executed by the content provisioning platform 103 to determine if any content 117 matches or relates to the sample, i.e., content pertaining to Super Product X. When a match is found, the content provisioning platform 103 retrieves the content related to Super Product X and further transmits it to one or more user devices 101a-101n for rendering.

In certain embodiments, the content provisioning platform 103 maintains the database of target content 117 on behalf of one or more content providers, service providers, users, or a combination thereof. For example, in the case of content for Super Product X as mentioned above, the content may include an advertisement of X seconds, an interactive application, a survey, or any other content. The content may feature a combination of text, images, video, audio arrangements for conveying a specific message to the user of the device(s) to which the content is rendered. To accommodate different content rendering mediums, the content 117 may be generated in different formats accordingly—i.e., the advertisement of X seconds may be generated in audio, video and multimedia form. Under this scenario, the content provisioning platform 103 conforms to the format types, device capability, system capability and requirements of the user device it is to be rendered by. In addition, one or more environmental signals sampled in one format, i.e., audio, can be effectively associated with its video counterpart as maintained in the database 117 for enabling different means of presentment/execution of the content among different device types.

The content provisioning platform 103 performs one or more analysis procedures for determining the type of signal the sample is related to as well. For example, the platform 103 tracks whether the sample corresponds to an audio signal as sampled according to a video format. Under this scenario, video data corresponding to the audio signal produced by a source 108a-108n is captured as the sample. In certain embodiments, the content provisioning platform 103 distinguishes between the sample format and the format of the corresponding signal—i.e., audio signal versus video signal—for enabling proper selection of corresponding target content to associate with the sample.

In one embodiment, the content provisioning platform 103 also processes context information associated with the one or more samples, the one or more environmental signals, or a combination thereof. This information is gathered by the platform 103 by way of a context processing module 109a-109n of respective user devices 101a-101n and stored in a context information database 111 on a per user profile 115 basis. By way of example, the content processing modules 109a-109n are configured to actively “listen” for context information in response to the active data capturing activities of the various sensors of the device. The various sensors, such as the audio recorder, may also be maintained in an active listening state for enabling persistent detection of one or more environmental signals. It is noted that samples of the various environmental signals may be presented to the content provisioning platform 103 by the context processing modules 109a-109n.

Context information 111 pertaining to device 101a may differ from that of device 101n; each set of context information being associated with the devices per distinct profile information 115 of the device, the associated users, etc. Context information 111 is used, for example, by the platform 103 to: (1) determine a relative location, venue, situation, activity or other contextual details that the sample pertains to; (2) facilitate the matching of a sampled environmental signal with target content 117 maintained by the platform 103; (3) determine the presence of one or more other user devices within proximity of the user device that provided the sample; and (4) a combination thereof. By way of example, the context information may include user device information, location information, user information, activity information, network information, or a combination thereof related to a user device 101a-101n that captured the sample or a user thereof. In addition, temporal information may also be processed for determining a relative time of capture of the sample.

The temporal information associated with the captured sample is used by the platform 103 to determine a specific set of content to be rendered by one or more devices of a user; particularly when the sample is determined to relate to a signal generated by or captured from a television, radio, multimedia source, data feed (e.g., podcast) or other source configured to execute programmed content. For instance, a time of receipt of the signal featuring theme music for a popular television program can be used to cross-reference television programs that run during a corresponding time slot. When a match is found (e.g., the matching television program content is identified), a list of featured content corresponding to the program is determined.

Hence, under this scenario, the one or more samples determined by the platform 103 pertains to content detected to be played, presented, transmitted or otherwise executed or rendered by a television, radio or other transmission medium at a given point in time. By way of example, a radio set to a specific station for broadcasting featured sporting news audio content at 9:09 am may be correlated with temporal information (e.g., a timestamp) of the sample indicating a creation time of 9:01 am. The content provisioning platform 103 employs various data analysis and recognition techniques for performing content lookup and matching.

By way of example, the one or more situational policies 113 correspond to various rules and procedures to be executed for matching a sampled environmental signal related to incidental content to various target content 117 as maintained. In certain embodiments, the situational policies 113 enable the content provisioning platform 103 to account for incidental content, i.e., the processing of samples of environmental signals that are not produced by a television, radio or other programmed signal source 108a-108n. By way of example, a sample of a person yelling “Hotdogs” at a football stadium can be generated and subsequently related to content for a local eatery in the vicinity of the stadium, a coupon for the purchase of hotdogs while at the stadium, a commercial for a preferred food vendor, or the like. Under this scenario, the platform 103 processes location information for determining a related set of content to retrieve from the target content database 117. In addition, the policies 113 may include a series of conditions, some of which are based on the context information, for enabling a specific content match to be determined. It is noted that the rules and procedures embodied as one or more policies may vary, and are therefore, subject to refinement by a provider of the content provisioning platform 103, one or more content providers, the various users of devices that interface with the platform 103, or a combination thereof. Also, it is noted that the policies 113 may be linked to a specific user or device profile 115.

Of note, matching target content 117 is selected based on a determined correlation between the sample under analysis, the current context information related, and one or more sets of the content 117. The sample as captured may correlate to multiple distinct sets of content—i.e., content for a commercial and a related article, both of which may be presented to a user device 101a solely or to devices 101a and 101n respectively. Once determined, the corresponding content and/or related content is packaged for transmission to at least the device (e.g., 101a) that generated the sample. When another device 101n is determined to be within proximity of the at least one device 101a and is designated in the profile 115 of the user, the content or other related content thereto is also transmitted to the other device 101n. The mode of transmission, corresponding protocols, and other data exchange factors vary depending on the capabilities of the device, preferred content rendering settings of the user as carried out by a content rendering module 110a-110n of respective devices and other factors.

In certain embodiments, the content provisioning platform 103 coordinates the rendering of the target content at respective devices 101a and 101n in response to determined sampled environmental signals. This may include, for example, timing the playback or stopping of content at the one or more devices 101a-101n, synchronizing the content for rendering concurrent with current television and/or radio programming as sampled, provisioning the content among available devices of the user based on timing factors, adapting the format of the content to meet different device capabilities, etc. By way of example, a user of a mobile phone and tablet device may receive content pertaining to a song being played by a radio device based on a sample of the song as captured by the tablet. Under this scenario, the tablet receives content in the form of an advertisement featuring the artist related to the song. The mobile phone receives content in the form of a text message for indicating a sweepstakes the user can participate in for attending a concert of the artist. The content provisioning platform 103 enables the content to be played at different times at respective devices, such as that the text message is received after the playing of the advertisement at the tablet device.

In certain embodiments, coordinated rendering and execution of the content is performed based on specific content execution settings stored in connection with the content. This may be in the form of metadata indicating one or more playback instructions or a content execution file maintained in connection with the content 117. Alternatively, the situational policies 113 may also pertain to one or more content execution settings. For example, timing settings, playback settings and user response settings may be configured as one or more policies for affecting the rendering of content at a device or related content at various other devices. It is contemplated that any means of instructing the content provisioning platform 103 for affecting rendering of content in conjunction with other content may be employed. Furthermore, specific timing settings and the like may be established by the service provider or content provider accordingly.

In certain embodiments, the content provisioning platform 103 enables execution of a content rendering interface for supporting viewing of content at a given device based on a determined environmental signal stimuli. By way of example, the content rendering interface may be implemented as a standalone module, i.e., as a content rendering module 110a-110n, capable of operation at a user device 101a-101n. As another example, the content rendering interface may be provided by the platform 103 as a widget or other executable for use in connection with a browser or web portal application of the device 101a-101n. The specific implementation may vary depending on device requirements. Regardless of the approach, however, the content rendering interface enables the user to interact with and view content at one or more related devices based on an acquired sample. As such, the content may be rendered concurrent with the signal generated pursuant to a current event, person, group, television program, or other source 108a-108n.

As shown in FIG. 1, the system 100 comprises user devices 101a-101n having connectivity to the content provisioning platform 103 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101a-101n is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101a-101n can support any type of interface to the user (such as “wearable” circuitry, etc.).

By way of example, the user devices 101a-101n and the content provisioning platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

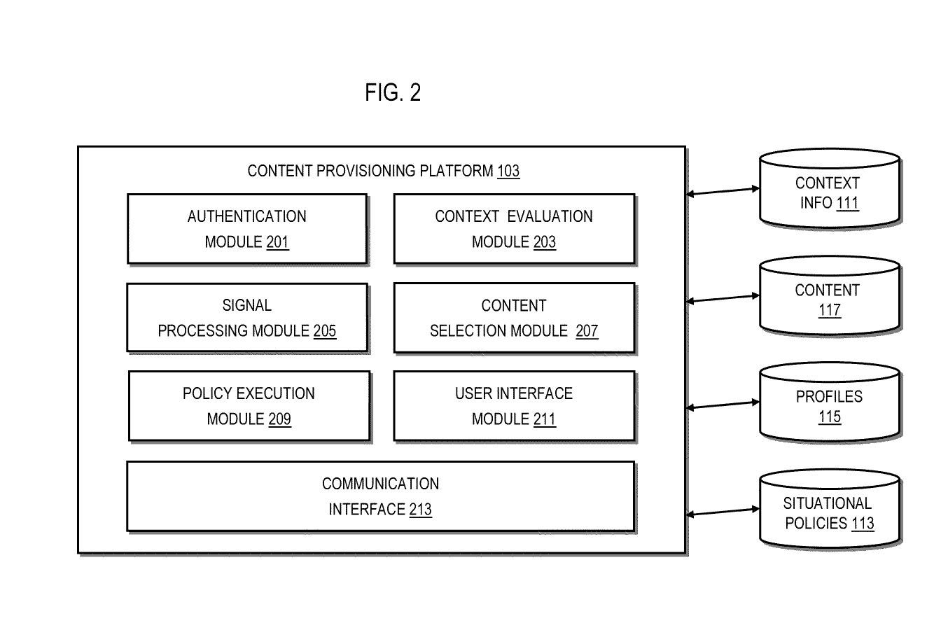

FIG. 2 is a diagram of the components of a content provisioning platform, according to one embodiment. By way of example, the content provisioning platform 103 includes one or more components for coordinating the rendering of related content across devices of a user based on determined environmental stimuli. It is contemplated that the functions of these components may be combined in one or more components or performed by other components of equivalent functionality. In this embodiment, the content provisioning platform 103 includes an authentication module 201, a context evaluation module 203, a signal processing module 205, a content selection module 207, a policy execution module 209, a user interface module 211 and a communication interface 213.

In addition, the content provisioning platform 103 maintains content 117 as well as context information 111 associated with the devices 101a-101n and/or one or more samples. Policy information 113 and profile information 115 is also maintained. It is noted that the modules 201-213 may access this data for performing various functions.

In one embodiment, an authentication module 201 authenticates users and user devices 101a-101n for interaction with the content provisioning platform 103. By way of example, the authentication module 201 receives a request to subscribe to the content provisioning platform 103, such as according to a service agreement. The subscription process may include the establishment of device preferences, context information gathering settings, etc. The authentication module 201 may also operate in connection with a user interface module 211 to receive feedback data from the user in response to the rendering of content.

The authentication process performed by the module 201 may also include receiving and validating a login name and/or user identification value as provided or established for a particular user during a subscription or registration process with the service provider. The login name and/or user identification value may be received as input provided by the user from the user device 101a-101n or other device via a graphical user interface to the content provisioning platform 103 (e.g., as enabled by user interface module 211). Registration data for respective subscribers, which contains pertinent user or device profile data, may be cross referenced as part of the login process. Alternatively, the login process may be performed through automated association of profile settings maintained as registration data with, for instance, an IP address, a carrier detection signal of a user device, mobile directory number (MDN), subscriber identity module (SIM) (e.g., of a SIM card), radio frequency identifier (RFID) tag or other identifier.

The authentication module 201 is also configured to receive and interpret requests from users of devices for retrieval of content related to a specific sampled environmental signal. By way of example, a request to retrieve content (if available) in response to a recording of a video game being rendered to a television display may be received and subsequently analyzed in connection with context information for determining matching content. Based on this request, the authentication module 201 triggers the activation of the other modules. The request includes samples as gathered by the various sensors of the device, and may be presented by way of the context processing module 109a-109n of a given device.

In one embodiment, the context evaluation module 203 processes the context information received from the context processing module 109a-109n of devices that generate various samples. The result of the processing, which may include determining an activity, environment, or current location or time of a sample, enables application of various policies by the policy execution module 209. For example, time and location information pertaining to the sample or the device that captured the sample may be used to determine that it is currently dinner time in a particular province of India. As such, for a sample featuring the keyword “dinner,” this determination may be used in connection with a policy enforced by the policy execution module 209 relative to the determined context. In this case, the policy may dictate that only those advertisements germane to the region be flagged for selection and retrieval from the content database 117 by the content selection module 207 as opposed to content featuring unsavory or offensive foods (e.g., dishes featuring certain meats). Hence, it is noted that the context evaluation module 203 operates in close connection with the content selection module 207 and policy execution module 209.

In one embodiment, a signal processing module 205 is configured to process one or more samples as received via a user device. By way of example, the signal processing module 205 analyzes the captured/sensed signal and determines it type. This may include determining if the signal is an audio signal corresponding to an audio source, a network signal corresponding to a network source, or a combination thereof. In the case of an audio signal, this may be provided by a radio, a television or any device capable of rendering audio data. In the case of a network signal, this may be transmitted by a server or content provider in the form of video, audio and/or multimedia data to a computing device, mobile device, set-top box, television or other receiver source.

In addition, the signal processing module 205 interprets signal content for matching purposes. For example, an audio signal featuring the theme music of a popular television program can be determined as content within the signal. This information can then be passed on to the featured content selection module 207, which determines whether the keyword, phrase, frequency, patterns, or other signal content corresponds to any available featured content. The analysis includes evaluation of one or more images, sounds, video, text or other data comprising the sample against known pattern detection, heuristic analysis, inference or deductive processing, object matching, ontological schemes, data recognition and other analysis models. It is noted that the signal processing module 205 may employ various known or still developing signal processing algorithms and content recognition techniques for performing the analysis.

In one embodiment, the content selection module 207 determines target content to be associated with the signal as analyzed by the signal processing module 205. A selection is made based on the results of the context evaluation module 203, time information associated with the signal as determined per the signal processing module 205, the analysis results of the signal processing module 205, one or more policies to be enforced by the policy execution module 209 based on the analysis, or a combination thereof. When a match is found (e.g., the matching television program content is identified), a list of featured content corresponding to the program is determined and readied for transmission to the requesting user device(s).

The featured content may include one or more segments of content to be played in various sequences and/or specific times during play of the television content. Each segment may correspond to a different form of content related to the sample as analyzed, including an advertisement, a game, a communication, additional television content, additional audio content, multimedia content, etc. Still further, each segment may correspond to a different contextual scenario, wherein the content selection module 207 determines which segment to associate with the determined audio signal based on the results of the context evaluation module 203.

In one embodiment, a communication interface 213 enables formation of a session over a network 105 between the content provisioning platform 103 and the various modules 109a-109n and 110a-110n at the user device 101a-101n. By way of example, the communication interface 213 executes various protocols and data sharing techniques for enabling collaborative exchange between a subscribed owner, sharer or viewer's user device 101a-101n (e.g., mobile devices, laptops, smartphones, tablet computers, desktop computers) and the platform 103. Of note, the communication interface 213 also supports the conveyance of content in the form of one or more remixes relative to a given set of policies associated with a specific user profile.

In one embodiment the user interface module 211 enables presentment of a graphical user interface for rendering content. In addition, the user interface module 211 enables the presentment of a user interface for facilitating the configuration of the one or more policies or user preferences. By way of example, the user interface module 211 generates the interface in response to application programming interfaces (APIs) or other function calls corresponding to the browser application or web portal application of the user devices 101a-101n; thus enabling the display of graphics primitives. In this case, the browser session may support execution of content playback in response to a determined sample of an environmental signal.

The above presented modules and components of the platform 103 can be implemented in hardware, firmware, software, or a combination thereof. In certain embodiments, the platform 103 can be a hosted solution offered by a service provider for access by one or more content providers and/or device users alike. Under this scenario, the platform may be embodied as server or cloud based solution available for access via the communication network 105. Though depicted as a separate entity in FIG. 1, it is also contemplated that the platform 103 may be implemented for direct operation by respective user devices 101a-101n. By way of example, the one or more modules 201-213 may be implemented for operation by respective user devices, and therefore, may generate direct signal inputs by way of the operating system of the user device 101a-101n.

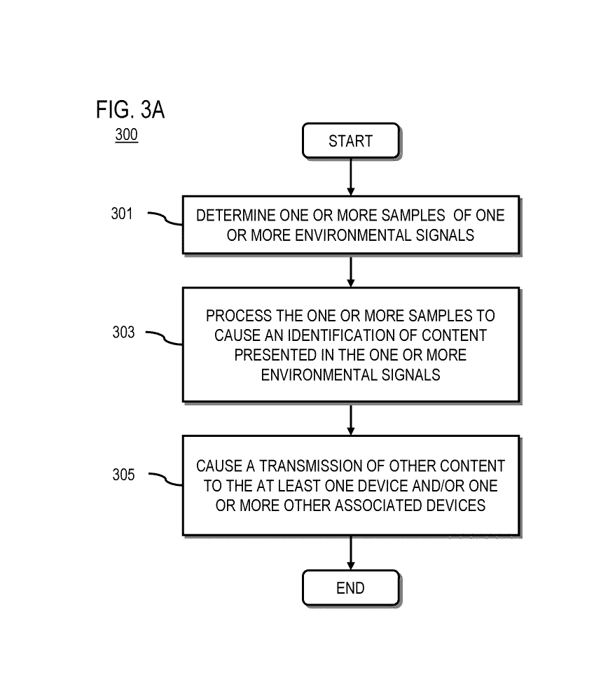

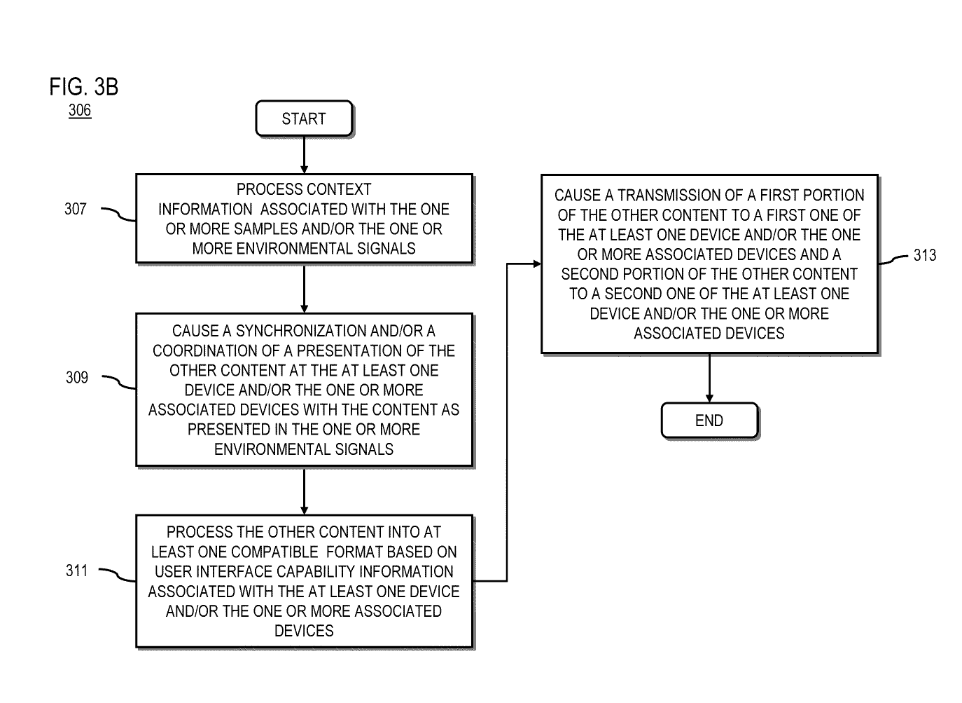

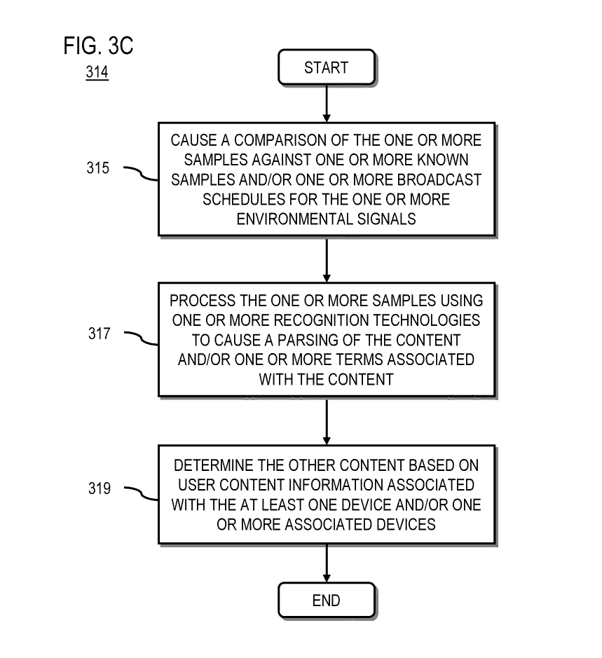

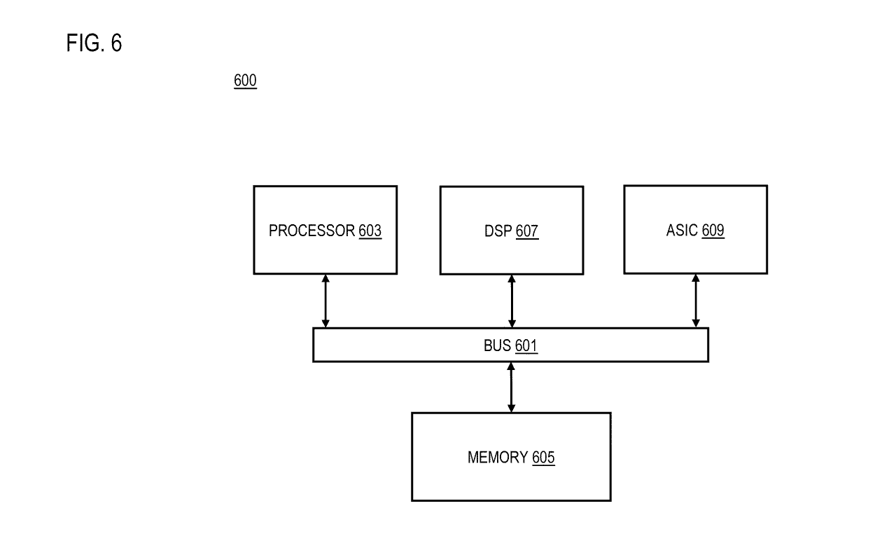

FIGS. 3A-3C are flowcharts of processes for coordinating the rendering of related content across devices of a user based on determined environmental stimuli, according to various embodiments. In one embodiment, the content provisioning platform 103 performs processes 300, 306 and 314 and is implemented in, for instance, a chip set including a processor and a memory as shown in FIG. 6.

In step 301, the platform 103 determines one or more samples of one or more environmental signals. As noted, the one or more samples correspond to environmental signals generated by various sources, including people, televisions, radios, objects, naturally occurring phenomena, etc. By way of example, the one or more samples are audio or video clips for conveying content according to a specified format. In step 303, the content provisioning platform 103 processes the one or more samples to cause an identification of content presented in the one or more environmental signals. This includes analysis of various keywords, images, sounds and other data that can be used to determine a match between the one or more samples and target content to be related to the one or more samples. Per step 305, the platform 103 causes a transmission of other content to the at least one device and/or one or more other associated devices. Of note, the other content is related to the identified content.

In step 307 of process 306 (FIG. 3B), the content provisioning platform 103 processes context information associated with the one or more samples and/or the one or more environmental signals. In another step 309, the platform 103 causes a synchronization and/or a coordination of a presentation of the other content at the at least one device and/or the one or more associated devices with the content as presented in the one or more environmental signals. As noted previously, the synchronization may include coordinating the playback timing of content at the at least one device or the one or more associated devices.

Per step 311, the content provisioning platform 103 processes the other content into at least one compatible format based on user interface capability information associated with the at least one device and/or the one or more associated devices. By way of example, the user interface capability varies from one device to another and may be specified accordingly per profile information pertaining to the device and/or the one or more associated devices. In another step 313, the platform 103 causes a transmission of a first portion of the other content to a first one of the at least one device and/or the one or more associated devices and a second portion of the other content to a second one of the at least one device and/or the one or more associated devices.

In step 315 of process 314 (FIG. 3C), the platform 103 causes a comparison of the one or more samples against one or more known samples and/or one or more broadcast schedules for the one or more environmental signals. In another step 317, the platform 103 processes the one or more samples using one or more recognition technologies to cause a parsing of the content and/or one or more terms associated with the content. In certain embodiments, the parsing may be performed based on various policies, wherein the policies specify the terms deemed to be of interest. Per step 319, the platform 103 determines the other content based on user content information associated with the at least one device and/or one or more associated devices

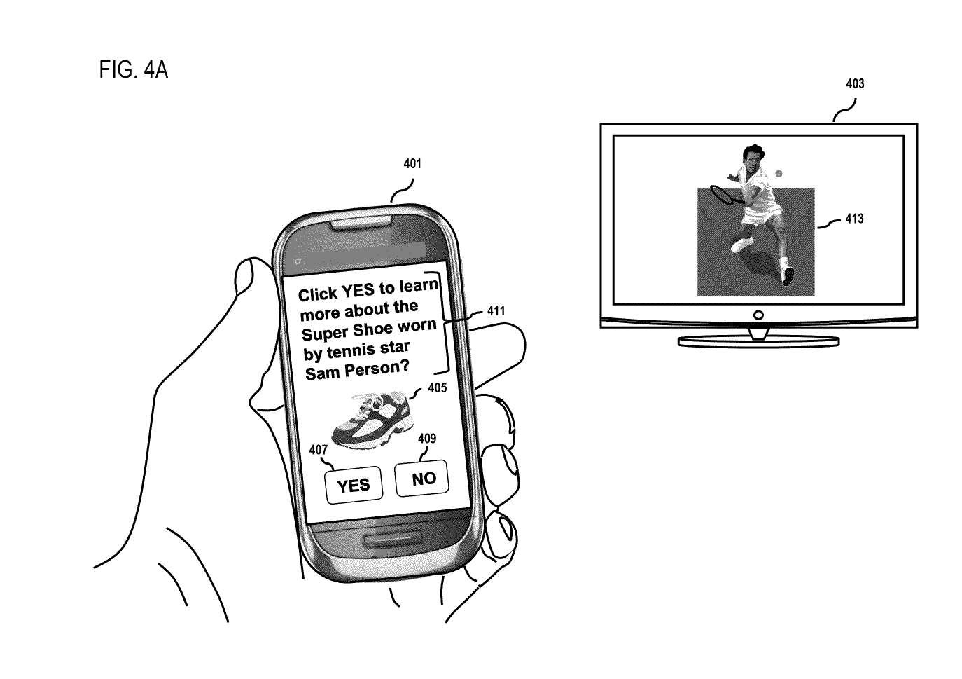

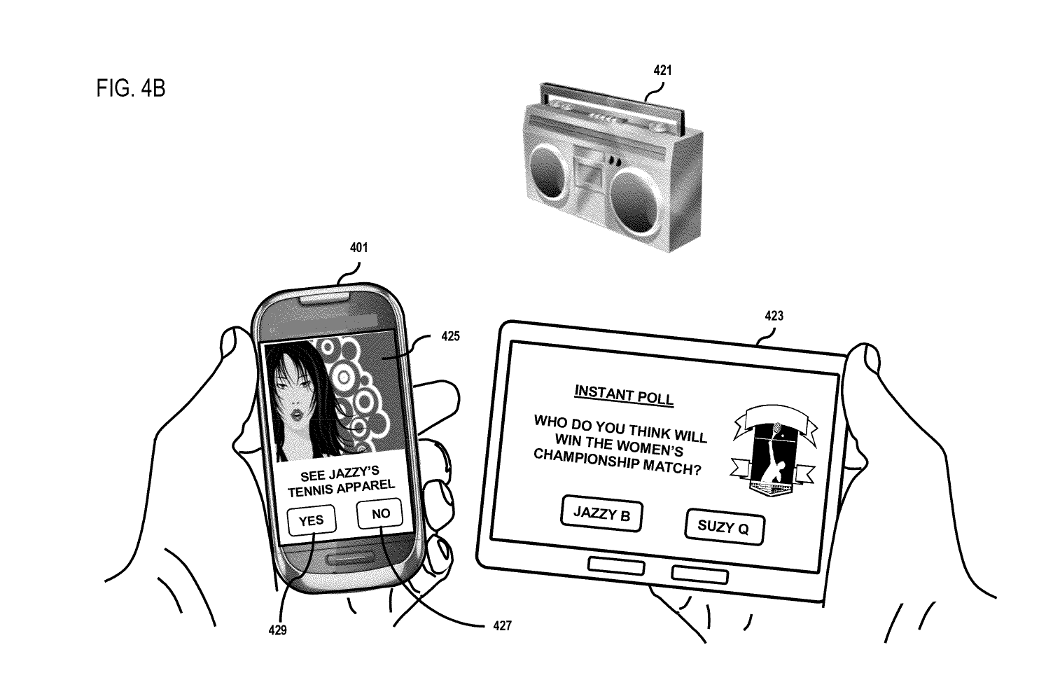

FIGS. 4A and 4B are diagrams of user interfaces utilized in the processes of FIGS. 3A-3C, according to various embodiments. For the purpose of illustration, the diagrams are presented from the perspective of a use case scenario of a user receiving content to one or more devices. Under this scenario, the content is transmitted to the devices based on a detected stimuli (environmental signals) provided by a television.

In FIG. 4A, a user of a device 401 views a tennis match from a television featuring a display 403. The match is presented on a particular channel and features a well known tennis player 413 named Sam Person. As the device 401 is maintained in an active listening mode for detecting environmental signals, audio samples of the tennis match are recorded by the device 401 for processing by the content provisioning platform 103. In addition, the content provisioning platform 103 receives context information such as location information and time information related to the device or the one or more samples.

Upon receipt of the sample and associated context information, the context provisioning platform 103 analyzes the sample and determines one or more references to the tennis match. This may include, for example, keywords related to the match or audio content for indicating the name of the player 413 Sam Person. In addition, the time information is cross-referenced against the content database to determine specific content related to tennis that matches the corresponding time frame. Under this scenario, the context provisioning platform 103 cross references a listing of channels and associated target content. Once the match is determined, the content is packaged and transmitted to the device 401.

In this scenario, the content is an interactive advertisement for a shoe product of which the tennis player 413 is an active endorser. The content features a message 411, a picture of the advertised product 405 and one or more action buttons 407 and 409 for receiving a user response input. It is noted that the content as presented to the device 401 is directly related to the tennis match as presented to the television display 403. Still further, additional related content may also be presented to correspond to match determined changes in the game, as detected via subsequent samples. Of note, the content presented may vary depending on the location of the user as well.

In FIG. 4B, the user decides to leave home and visit a sporting goods store to purchase a birthday gift for his wife. Under this scenario, the user takes his mobile device 401 and tablet computer 423 along with him. As his wife is an avid tennis player, the user goes to the women's tennis apparel section of the store to find a gift. A salesperson at the sporting goods store has a stereo 421 that is tuned to a sports channel, which is currently providing coverage of a women's championship tennis match. The match features a popular tennis star Jazzy Breakpoint.

Upon detecting a signal (e.g., audio signal) produced by the radio 421, the mobile device 401 generates a sample and presents it to the content provisioning platform 103. In addition, updated location information and time information is presented to the platform 103 for indicating the user is at the sporting goods store and that the audio sample corresponds to a programmed listing of radio content. Based on analysis of the sample and the associated context information, the platform 103 determines various sets of content to be presented to device 401 in a coordinated fashion. In addition, having detected the availability (e.g., proximity) of the tablet device 423 of the user, the context provisioning platform 103 used various policies to enable concurrent, coordinated presentment of content to both of the devices in response to the radio 421 broadcast.

Under this scenario, the mobile device receives an advertisement in the form of a video (commercial) for women's tennis apparel sponsored by Jazzy Breakpoint. When the user selects the YES action button 429, they are presented with coupons offers, location maps, and other content that is directly related to the tennis match and the sporting goods store for supporting the purchase of apparel. This is in response to the analysis of the sample performed by the content provisioning platform 103, which determined the name/keyword of the tennis player as content within the sample. In addition, the location information was used to enable the transmission of content that is specifically related to the current location of the user.

Also, the tablet device 423 is caused to present a poll for receiving user feedback regarding the outcome of the women's tennis championship. In this example, the poll is presented to the tablet device 423 in a delayed manner per one or more timing requirements. Alternatively, the poll can be presented to the tablet 423 at exactly the same time as the video content, presented in response to a condition being met with respect to the video content, of according to other sequencing and synchronization approaches. By way of example, the poll may be presented to the tablet 421 on a conditional basis, per various situational policies. Under this scenario, content is only presented to the tablet when the NO action button 427 is selected by the user in response to the video based advertisement 425. It is contemplated in future embodiments that the content provisioning platform may be configured to associated discounts and incentive information in conjunction with the featured content in relation to the retailer. This may include integration of the content provisioning platform 103 with various systems for enabling location based incentive programs, radio frequency identifier tracking, etc.

The processes described herein for coordinating the rendering of related content across devices of a user based on determined environmental stimuli may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

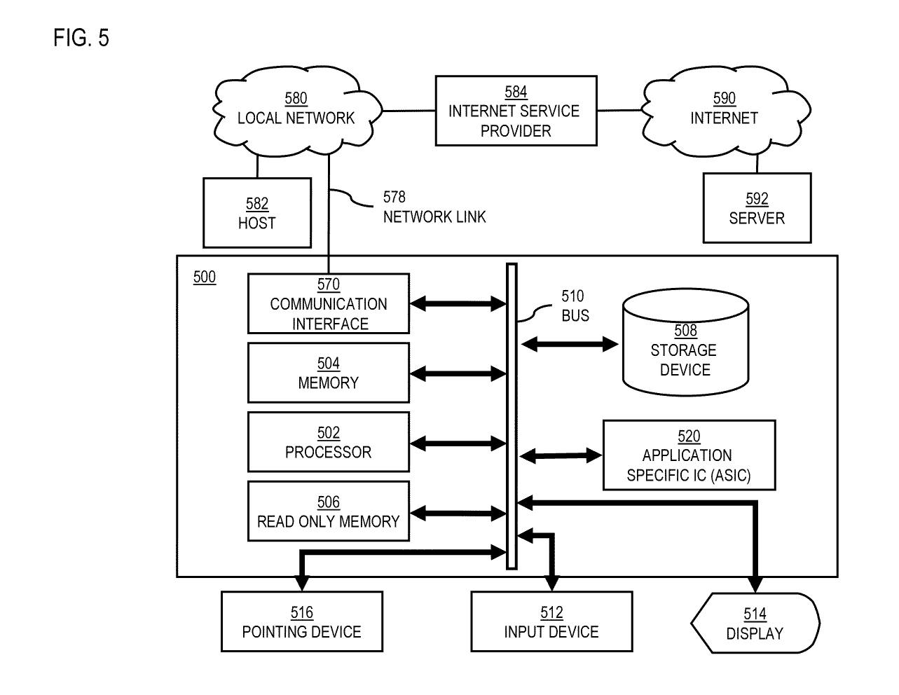

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to coordinate the rendering of related content across devices of a user based on determined environmental stimuli as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of coordinating the rendering of related content across devices of a user based on determined environmental stimuli.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to coordinate the rendering of related content across devices of a user based on determined environmental stimuli. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for coordinating the rendering of related content across devices of a user based on determined environmental stimuli. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for coordinating the rendering of related content across devices of a user based on determined environmental stimuli, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for coordinating the rendering of related content across devices of a user based on determined environmental stimuli to the UE 101a-101n.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to coordinate the rendering of related content across devices of a user based on determined environmental stimuli as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of coordinating the rendering of related content across devices of a user based on determined environmental stimuli.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to coordinate the rendering of related content across devices of a user based on determined environmental stimuli. The memory 605 also stores the data associated with or generated by the execution of the inventive steps.

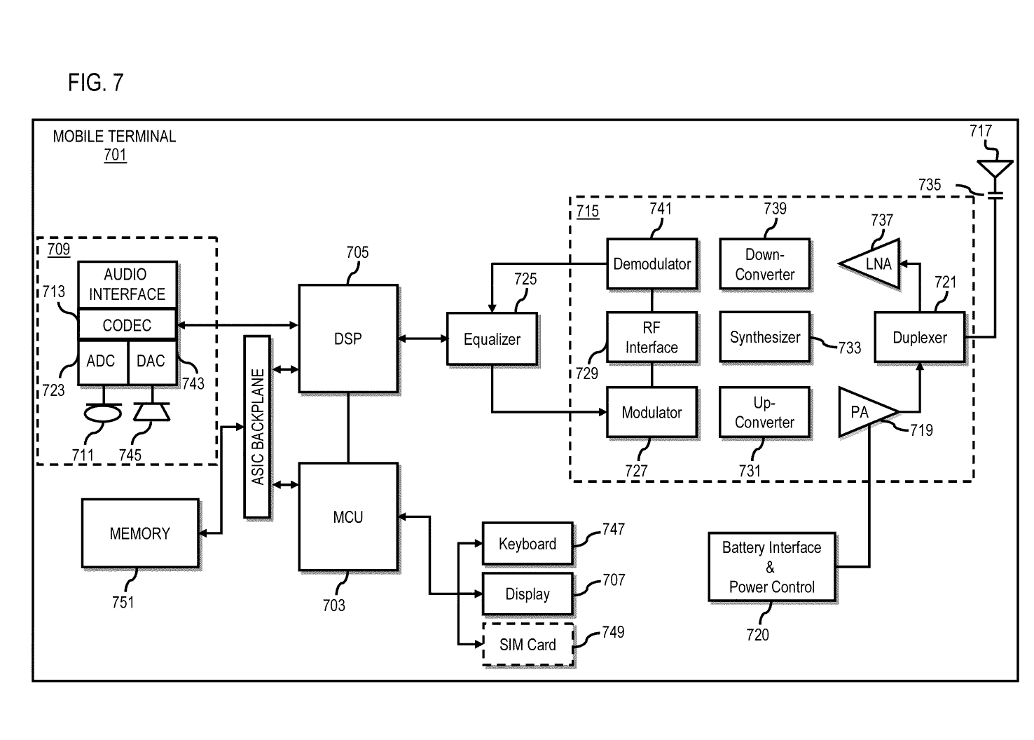

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of coordinating the rendering of related content across devices of a user based on determined environmental stimuli. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of coordinating the rendering of related content across devices of a user based on determined environmental stimuli. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720. In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks. Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to coordinate the rendering of related content across devices of a user based on determined environmental stimuli. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
one or more samples of one or more environmental signals, wherein the one or more samples are captured by at least one device;
a processing of the one or more samples to cause, at least in part, an identification of content presented in the one or more environmental signals; and
a transmission of other content to the at least one device, one or more other associated devices, or a combination thereof,
wherein the other content is related to the identified content.

2. A method of claim 1, wherein the (1) data and/or (2) information and/or (3) at least one signal are further based, at least in part, on the following:
a processing of context information associated with the one or more samples, the one or more environmental signals, or a combination thereof,
wherein the identification of the content is further based, at least in part, on the context information.

3. A method of claim 1, wherein the one or more environmental signals are associated with broadcast programming, and wherein the other content is associated with advertisement information, related programming, related applications, related services, or combination thereof.

4. A method of claim 1, wherein the (1) data and/or (2) information and/or (3) at least one signal are further based, at least in part, on the following:
a synchronization, a coordination, or a combination thereof of a presentation of the other content at the at least one device, the one or more associated devices, or a combination thereof with the content as presented in the one or more environmental signals.

5. A method of claim 1, wherein the (1) data and/or (2) information and/or (3) at least one signal are further based, at least in part, on the following:
a processing of the other content into at least one compatible format based, at least in part, on user interface capability information associated with the at least one device, the one or more associated devices, or a combination thereof.

6. A method of claim 1, wherein the (1) data and/or (2) information and/or (3) at least one signal are further based, at least in part, on the following:
a transmission of a first portion of the other content to a first one of the at least one device, the one or more associated devices, or a combination thereof and a second portion of the other content to a second one of the at least one device, the one or more associated devices, or a combination thereof,
wherein the first portion and the second portion are different.

7. A method of claim 1, wherein the (1) data and/or (2) information and/or (3) at least one signal are further based, at least in part, on the following:
a comparison of the one or more samples against one or more known samples, one or more broadcast schedules for the one or more environmental signals, or a combination thereof,
wherein the identification of content is based, at least in part, on the comparison.

8. A method of claim 1, wherein the (1) data and/or (2) information and/or (3) at least one signal are further based, at least in part, on the following:
a processing of the one or more samples using one or more recognition technologies to cause, a least in part, a parsing of the content, one or more terms associated with the content, or a combination thereof,
wherein the identification of the content is based, at least in part, on the parsing.

9. A method of claim 1, wherein the one or more samples include, at least in part, one or more audio samples, one or more video samples, or a combination thereof.

10. A method of claim 1, wherein the (1) data and/or (2) information and/or (3) at least one signal are further based, at least in part, on the following:
at least one determination of the other content based, at least in part, on user content information associated with the at least one device, one or more associated devices, or a combination thereof.

11. An apparatus comprising:
at least one processor; and
at least one memory including computer program code for one or more programs,
the at least one memory and the computer program code configured to, with the at least one processor, cause the apparatus to perform at least the following,
determining one or more samples of one or more environmental signals, wherein the one or more samples are captured by at least one device;
processing and/or facilitating a processing of the one or more samples to cause, at least in part, an identification of content presented in the one or more environmental signals; and
causing, at least in part, a transmission of other content to the at least one device, one or more other associated devices, or a combination thereof,
wherein the other content is related to the identified content.

12. An apparatus of claim 11, wherein the apparatus is further caused to:
processing and/or facilitating a processing of context information associated with the one or more samples, the one or more environmental signals, or a combination thereof,
wherein the identification of the content is further based, at least in part, on the context information.

13. An apparatus of claim 11, wherein the one or more environmental signals are associated with broadcast programming, and wherein the other content is associated with advertisement information, related programming, related applications, related services, or combination thereof.

14. An apparatus of claim 11, wherein the apparatus is further caused to:
causing, at least in part, a synchronization, a coordination, or a combination thereof of a presentation of the other content at the at least one device, the one or more associated devices, or a combination thereof with the content as presented in the one or more environmental signals.

15. An apparatus of claim 11, wherein the apparatus is further caused to:
processing and/or facilitating a processing of the other content into at least one compatible format based, at least in part, on user interface capability information associated with the at least one device, the one or more associated devices, or a combination thereof.

16. An apparatus of claim 11, wherein the apparatus is further caused to:
causing, at least in part, a transmission of a first portion of the other content to a first one of the at least one device, the one or more associated devices, or a combination thereof and a second portion of the other content to a second one of the at least one device, the one or more associated devices, or a combination thereof,
wherein the first portion and the second portion are different.

17. An apparatus of claim 11, wherein the apparatus is further caused to:
causing, at least in part, a comparison of the one or more samples against one or more known samples, one or more broadcast schedules for the one or more environmental signals, or a combination thereof,
wherein the identification of content is based, at least in part, on the comparison.

18. An apparatus of claim 11, wherein the apparatus is further caused to:
processing and/or facilitating a processing of the one or more samples using one or more recognition technologies to cause, a least in part, a parsing of the content, one or more terms associated with the content, or a combination thereof,
wherein the identification of the content is based, at least in part, on the parsing.

19. An apparatus of claim 11, wherein the one or more samples include, at least in part, one or more audio samples, one or more video samples, or a combination thereof.

20. An apparatus of claim 11, wherein the apparatus is further caused to:
determining the other content based, at least in part, on user content information associated with the at least one device, one or more associated devices, or a combination thereof.

21-48. (canceled)
